(19) United States
(12) Patent Application Publication
(10) Pub. No.: US 2007/0236972 A1
(43) Pub. Date: Oct. 11, 2007

(54) Semiconductor integrated circuit device, charge pump circuit, and electric appliance

(76) Inventor: Yoshinori Imanaka, Kyoto-shi (JP)

Correspondence Address: FISH & RICHARDSON P.C., P.O. BOX 1022, MINNEAPOLIS, MN, 55440-1022, US

(21) Appl. No.: 11/726,344

(22) Filed: Mar. 20, 2007

(30) Foreign Application Priority Data
Mar. 22, 2006 (JP) 2006-077964

(51) Int. Cl. H02M 3/18; H02M 7/00

(52) U.S. Cl. 363/60

(57) ABSTRACT

In addition to an input terminal, an output terminal, a ground terminal, a plurality of external terminals, and a plurality of charge transfer switches, a semiconductor integrated circuit device has a step-up factor switching terminal. Here, the plurality of charge transfer switches each have a common contact connected to corresponding one of the plurality of external terminals and two selection contacts alternatively connected to the common contact, and one of the selection contacts of the plurality of charge transfer switches is connected to the step-up factor switching terminal, and each of the other selection contacts is connected to one of the input terminal, the output terminal, the ground terminal, and the rest of the other selection contacts. With this configuration, it is possible to make the semiconductor integrated circuit device versatile so that it can be used to form charge pump circuits having different step-up factors.

This application is based on Japanese Patent Application No. 2006-077964 filed on Mar. 22, 2006, the contents of which are hereby incorporated by reference.

### BACKGROUND OF THE INVENTION

1. Field of the Invention

The present invention relates to semiconductor integrated circuit devices for use in charge pump circuits, and more particularly to a step-up factor changing technique adopted thereby.

2. Description of Related Art

FIG. 9 is a circuit diagram showing an example of a conventional charge pump circuit. A charge pump circuit 100 shown in this figure produces, from an input voltage Vi, a desired output voltage Vo (=2Vi) by turning a plurality of charge transfer switches 101 to 104 ON/OFF at regular intervals according to a clock signal (not shown) in such a way as to charge and discharge a charge transfer capacitor 105.

The above-described positive stepping-up will be specifically described. The output voltage Vo is produced as follows. First, during a charging period, the switches 101 and 102 are turned ON and the switches 103 and 104 are turned OFF. As a result of this switching, the input voltage Vi is applied to one end (point A) of the capacitor 105, and a ground voltage GND is applied to the other end thereof (point B). Thus, the capacitor 105 is charged until the potential difference across it becomes approximately equal to the input voltage Vi.

After the capacitor 105 is fully charged, during a pumping period, the switches 101 and 102 are turned OFF and the switches 103 and 104 are turned ON. As a result of this switching, the potential at the point B is stepped up from the ground voltage GND to the input voltage Vi. Here, since the capacitor 105 has previously been charged so that now a potential difference approximately equal to the input voltage Vi is present across it, when the potential at the point B is stepped up to the input voltage Vi, simultaneously the potential at the point A is stepped up to 2Vi (=the input voltage Vi plus the charging voltage Vi). At this point, since the point A is connected to the ground terminal via the switch 104 and an output capacitor 106, the output capacitor 106 is charged until the potential difference across it becomes approximately equal to 2Vi.

As described above, the charge pump circuit 100 turns the switches 101 to 104 ON/OFF at regular intervals, producing alternating periods of charging and pumping, so that the voltage 2Vi obtained by positively stepping up the input voltage Vi by a factor of 2 is outputted as the output voltage Vo.

As a conventional technology related to what has been described thus far, there have been disclosed and proposed various charge pump circuits (see, for example, JP-A-2000-262044).

Certainly, with the charge pump circuit 100 described above, it is possible to produce a desired output voltage Vo (=2Vi) by positively stepping up the input voltage Vi.

In general, the conventional charge pump circuits adopt a configuration where a plurality of charge transfer switches described above are integrated into a semiconductor integrated circuit device, to which a charge transfer capacitor is externally fitted. Such a semiconductor integrated circuit device is usually designed specifically to perform stepping-up by a given factor, for example, a factor of 2 or 3. This gives a charge pump circuit provided with such a semiconductor integrated circuit device a fixed step-up factor.

Thus, to form charge pump circuits having different step-up factors, the user has to choose appropriate semiconductor integrated circuit devices, each being designed according to a desired step-up factor, and obtain them separately. On the other hand, the manufacturers of the semiconductor integrated circuit devices are required to make available a wide range of semiconductor integrated circuit devices having different step-up factors to meet the user's intended purposes. This undesirably results in reduced production efficiency.

### SUMMARY OF THE INVENTION

In view of the conventionally experienced problems described above, an object of the present invention is to provide versatile semiconductor integrated circuit devices that can be used to form charge pump circuits having different step-up factors, and to provide charge pump circuits and electric appliances provided with such semiconductor integrated circuit devices.

To achieve the above object, according to one aspect of the invention, a semiconductor integrated circuit device includes: an input terminal to which an input voltage is applied; an output terminal from which an output voltage is outputted; a ground terminal to which a ground voltage is applied; a plurality of external terminals to which a charge transfer capacitor is externally fitted; and a plurality of charge transfer switches provided one for each of the external terminals. Here, the plurality of charge transfer switches each have a common contact connected to corresponding one of the external terminals and two selection contacts alternatively connected to the common contact. Furthermore, one of the selection contacts of the plurality of charge transfer switches is connected to a step-up factor switching terminal that can be externally connected to at least one of the input terminal and the plurality of external terminals, and each of the other selection contacts is connected to one of the input terminal, the output terminal, the ground terminal, and the rest of the other selection contacts.

Other features, elements, steps, advantages and characteristics of the present invention will become more apparent from the following detailed description of preferred embodiments thereof with reference to the attached drawings.

### BRIEF DESCRIPTION OF THE DRAWINGS

FIG. 1 is a diagram showing an embodiment of a semiconductor integrated circuit device according to the invention;

FIG. 2 is a diagram showing an example of the connection relationship when stepping-up by a factor of 2 is performed;

FIG. 3 is a diagram showing an example of the connection relationship when stepping-up by a factor of 3 is performed;

FIG. 4 is a diagram showing an example of the connection relationship when stepping-up by a factor of 4 is performed;

FIG. 5 is a diagram showing an example of the connection relationship when stepping-up by a factor of 5 is performed;

FIG. 6 is a diagram showing an example of the connection relationship when stepping-up by a factor of 6 is performed;

FIG. 7 is a diagram showing an example of the connection relationship when stepping-up by a factor of 7 is performed;

FIG. 8 is a block diagram showing a portable device incorporating a charge pump circuit according to the invention; and

FIG. 9 is a circuit diagram showing an example of a conventional charge pump circuit.

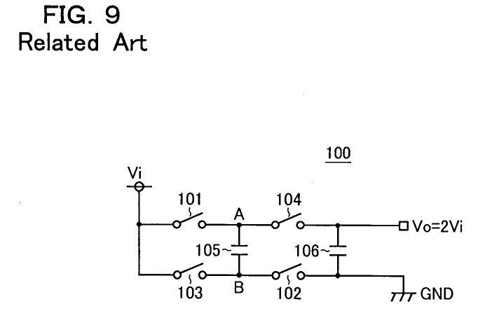

### DETAILED DESCRIPTION OF PREFERRED EMBODIMENTS

Hereinafter, the present invention will be described by way of an example in which it is applied to a versatile semiconductor integrated circuit device that can be used to form two- to sevenfold step-up charge pump circuits.

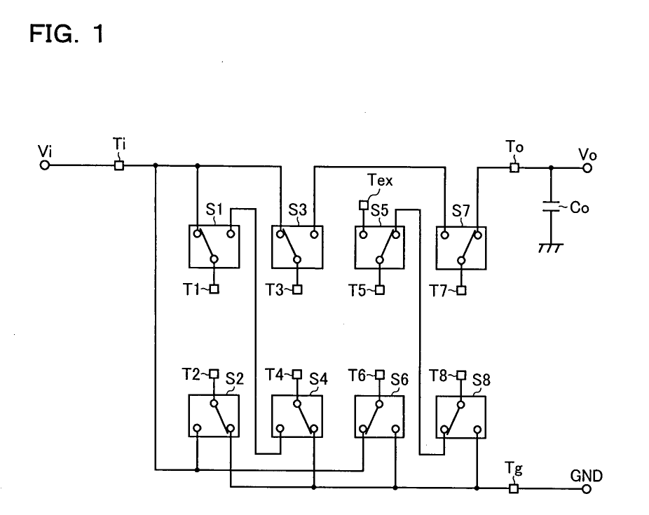

FIG. 1 is a diagram showing an embodiment of a semiconductor integrated circuit device according to the invention.

As shown in FIG. 1, in addition to an input terminal Ti to which an input voltage Vi is applied, an output terminal To from which an output voltage Vo is outputted, a ground terminal Tg to which a ground voltage GND is applied, external terminals T1 to T8 to which a charge transfer capacitor (not shown in this figure) is externally fitted, and charge transfer switches S1 to S8 that are provided one for each of the external terminals T1 to T8 and are each formed as a MOSFET or a bipolar transistor, the semiconductor integrated circuit device includes a step-up factor switching terminal Tex that can change the terminal to which it is connected according to a step-up factor.

The charge transfer switches S1 to S8 each have a common contact connected to a corresponding one of the external terminals T1 to T8 and two selection contacts (first and second selection contacts) alternatively connected to the common contact, the two selection contacts being connected to the common contact one at a time.

The charge transfer switch S1 is connected, at a first selection contact thereof, to the input terminal Ti and is connected, at a second selection contact thereof, to a first selection contact of the charge transfer switch S4. The charge transfer switch S2 is connected, at a first selection contact thereof, to the input terminal Ti and is connected, at a second selection contact thereof, to the ground terminal Tg. The charge transfer switch S3 is connected, at a first selection contact thereof, to the input terminal Ti and is connected, at a second selection contact thereof, to a first selection contact of the charge transfer switch S7. The charge transfer switch S4 is connected, at a second selection contact thereof, to the ground terminal Tg. The charge transfer switch S5 is connected, at a first selection contact thereof, to the step-up factor switching terminal Tex and is connected, at a second selection contact thereof, to a first selection contact of the charge transfer switch S8. The charge transfer switch S6 is connected, at a first selection contact thereof, to the input terminal Ti and is connected, at a second selection contact thereof, to the ground terminal Tg. The charge transfer switch S7 is connected, at a second selection contact thereof, to the output terminal To. The charge transfer switch S8 is connected, at a second selection contact thereof, to the ground terminal Tg.

Path switching control is performed for the charge transfer switches S1, S3, S6, and S8 and for the charge transfer switches S2, S4, S5, and S7 in such a way that the former become opposite in phase to the latter. More specifically, when the common contacts of the charge transfer switches S1, S3, S6, and S8 are connected to their respective first selection contacts, the common contacts of the charge transfer switches S2, S4, S5, and S7 are connected to their respective second selection contacts. On the other hand, when the common contacts of the charge transfer switches S1, S3, S6, and S8 are connected to their respective second selection contacts, the common contacts of the charge transfer switches S2, S4, S5, and S7 are connected to their respective first selection contacts.

With the semiconductor integrated circuit device configured as described above, by appropriately changing the terminal to which the step-up factor switching terminal Tex is externally connected and changing how many and where charge transfer capacitors are connected between the external terminals T1 to T8, it is possible to change the internal circuit configuration thereof to any desired configuration. This makes it possible to set a step-up factor of a charge pump circuit built with this semiconductor integrated circuit device to any desired factor in the two- to sevenfold range.

Hereinafter, how to form two- to sevenfold step-up charge pump circuits by using the semiconductor integrated circuit device of this embodiment will be specifically described.

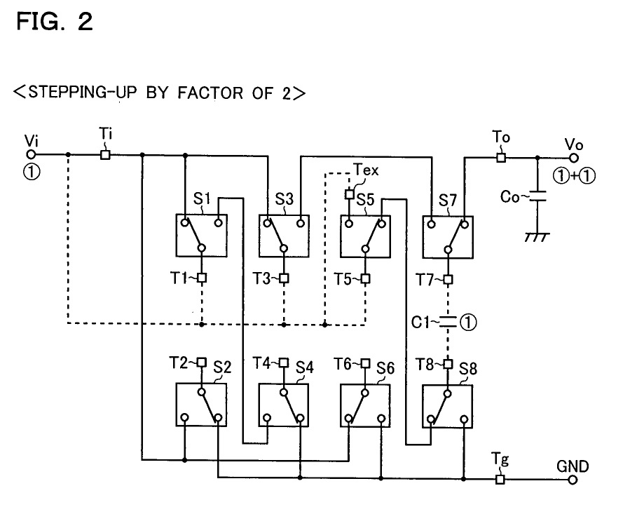

First, how to form a twofold charge pump circuit will be specifically described with reference to FIG. 2. FIG. 2 is a diagram showing an example of the connection relationship when stepping-up by a factor of 2 is performed.

As indicated by dashed lines in FIG. 2, to realize stepping-up by a factor of 2, a charge transfer capacitor C1 is externally connected between the external terminal T7 and the external terminal T8. Furthermore, the input terminal Ti, the external terminal T1, the external terminal T3, and the external terminal T5 are externally connected to the step-up factor switching terminal Tex.

In the charge pump circuit configured as described above, the external terminal T7 (one end of the capacitor C1) and the external terminal T8 (the other end of the capacitor C1) are first connected respectively to the input terminal Ti via the switch S7 and the switch S3 and to the ground terminal Tg via the switch S8 (a first state). As a result of this switching, the input voltage Vi is applied to the external terminal T7, and the ground voltage GND is applied to the external terminal T8. Thus, the capacitor C1 is charged until the potential difference across it becomes approximately equal to the input voltage Vi. It is to be noted that, throughout the present specification, a circled number in the figures (for example, “1” in FIG. 2) denotes how many times the charging voltage of the capacitor (for example, the capacitor C1 in FIG. 2) is higher than the input voltage Vi.

After the capacitor C1 is fully charged, the external terminal T8 and the external terminal T7 are then connected respectively to the input terminal Ti via the switch S8 and the switch S5 and to the output terminal To via the switch S7 (a second state). As a result of this switching, the potential at the external terminal T8 is stepped up from the ground voltage GND to the input voltage Vi. Here, since the capacitor C1 has previously been charged so that now a potential difference approximately equal to the input voltage Vi is present across it, when the potential at the external terminal T8 is stepped up to the input voltage Vi, simultaneously the potential at the external terminal T7 is stepped up to 2Vi (=the input voltage Vi plus the charging voltage Vi of the capacitor C1). At this point, since the external terminal T7 is grounded via the switch S7 and the output capacitor Co, the output capacitor Co is charged until the potential difference across it becomes approximately equal to 2Vi.

As described above, in the charge pump circuit of this embodiment, the switches S1 to S8 are switched at regular intervals, producing alternating first and second states described above, so that the capacitor C1 is charged and discharged. As a result, an output voltage Vo (=2Vi) obtained by positively stepping up the input voltage Vi by a factor of 2 is outputted from the output terminal To.

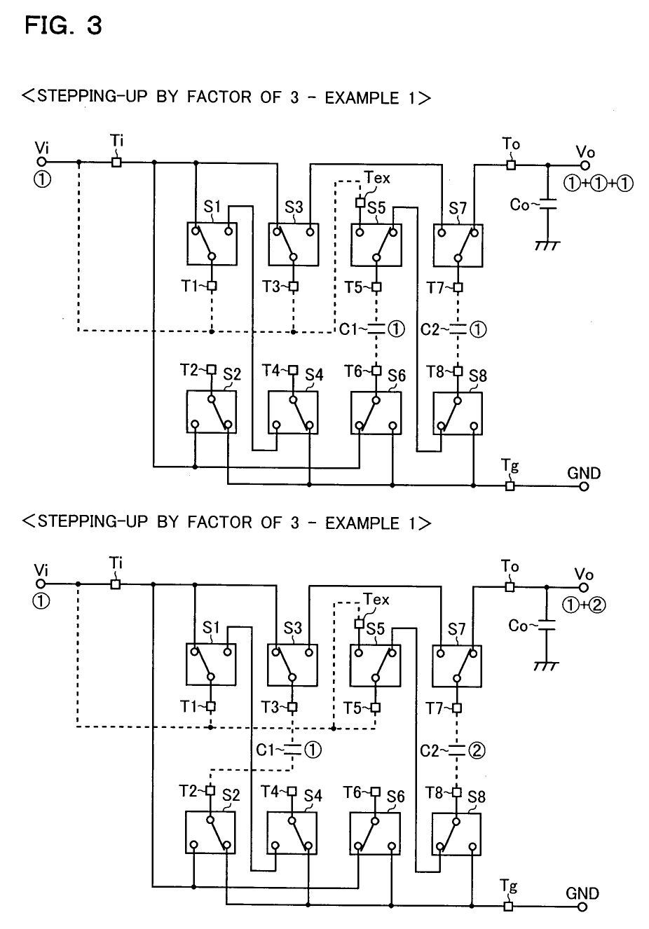

Next, how to form a threefold charge pump circuit will be specifically described with reference to FIG. 3. FIG. 3 is a diagram showing an example of the connection relationship when stepping-up by a factor of 3 is performed.

As indicated by dashed lines in Example 1 of FIG. 3, to realize stepping-up by a factor of 3, a charge transfer capacitor C1 is externally connected between the external terminal T5 and the external terminal T6, a charge transfer capacitor C2 is externally connected between the external terminal T7 and the external terminal T8. Furthermore, the input terminal Ti, the external terminal T1, and the external terminal T3 are externally connected to the step-up factor switching terminal Tex.

In the charge pump circuit configured as described above, the external terminal T5 (one end of the capacitor C1), the external terminal T6, the external terminal T7 (one end of the capacitor C2), and the external terminal T8 (the other end of the capacitor C2) are first connected respectively to the input terminal Ti via the switch S5, to the ground terminal Tg via the switch S6, to the input terminal Ti via the switch S7 and the switch S3, and to the ground terminal Tg via the switch S8 (a first state). As a result of this switching, the input voltage Vi is applied to the external terminal T5 and to the external terminal T7, and the ground voltage GND is applied to the external terminal T6 and to the external terminal T8. Thus, the capacitor C1 and the capacitor C2 are each charged until the potential difference across them becomes approximately equal to the input voltage Vi.

After the capacitor C1 and the capacitor C2 are fully charged, the external terminal T6, the external terminal T5, and the external terminal T7 are then connected respectively to the input terminal Ti via the switch S6, to the external terminal T8 via the switch S5 and the switch S8, and to the output terminal To via the switch S7 (a second state). As a result of this switching, the potential at the external terminal T6 is stepped up from the ground voltage GND to the input voltage Vi. Here, since the capacitor C1 and the capacitor C2 each have previously been charged so that now a potential difference approximately equal to the input voltage Vi is present across them, when the potential at the external terminal T6 is stepped up to the input voltage Vi, simultaneously the potential at the external terminal T7 is stepped up to 3Vi (=the input voltage Vi plus the charging voltage Vi of the capacitor C1 plus the charging voltage Vi of the capacitor C2). At this point, since the external terminal T7 is grounded via the switch S7 and the output capacitor Co, the output capacitor Co is charged until the potential difference across it becomes approximately equal to 3Vi.

As described above, in the charge pump circuit of this embodiment, the switches S1 to S8 are switched at regular intervals, producing alternating first and second states described above, so that the capacitor C1 and the capacitor C2 are charged and discharged. As a result, an output voltage Vo (=3Vi) obtained by positively stepping up the input voltage Vi by a factor of 3 is outputted from the output terminal To.

Alternatively, as indicated by dashed lines in Example 2 of FIG. 3, to realize stepping-up by a factor of 3, the charge transfer capacitor C1 may be externally connected between the external terminal T2 and the external terminal T3, the charge transfer capacitor C2 may be externally connected between the external terminal T7 and the external terminal T8. Furthermore, the input terminal Ti, the external terminal T1, and the external terminal T5 may be externally connected to the step-up factor switching terminal Tex.

In the charge pump circuit configured as described above, the external terminal T3 (one end of the capacitor C1) and the external terminal T2 (the other end of the capacitor C1) are first connected respectively to the input terminal Ti via the switch S3 and to the ground terminal Tg via the switch S2 (a first state). As a result of this switching, the input voltage Vi is applied to the external terminal T3, and the ground voltage GND is applied to the external terminal T2. Thus, the capacitor C1 is charged until the potential difference across it becomes approximately equal to the input voltage Vi.

After the capacitor C1 is fully charged, then the external terminal T2 is connected to the input terminal Ti via the switch S2, the external terminal T3 is connected to the external terminal T7 (one end of the capacitor C2) via the switch S3 and the switch S7, and the external terminal T8 (the other end of the capacitor C2) is connected to the ground terminal Tg via the switch S8 (a second state). As a result of this switching, the potential at the external terminal T2 is stepped up from the ground voltage GND to the input voltage Vi. Here, since the capacitor C1 has previously been charged so that now a potential difference approximately equal to the input voltage Vi is present across it, when the potential at the external terminal T2 is stepped up to the input voltage Vi, simultaneously the potential at the external terminal T3 is stepped up to 2Vi (=the input voltage Vi plus the charging voltage Vi of the capacitor C1). At this point, since the external terminal T3 is connected to the ground terminal Tg via the switch S3, the switch S7, the capacitor C2, and the switch S8, the capacitor C2 is charged until the potential difference across it becomes approximately equal to 2Vi.

After the capacitor C2 is fully charged, when the switches S1 to S8 are returned to the first state, the external terminal T8 is connected to the input terminal Ti via the switch S8 and the switch S5, and the external terminal T7 is connected to the output terminal To via the switch S7. As a result of this switching, the potential at the external terminal T8 is stepped up from the ground voltage GND to the input voltage Vi. Here, since the capacitor C2 has previously been charged so that now a potential difference (2Vin) approximately twice as high as the input voltage Vi is present across it, when the potential at the external terminal T8 is stepped up to the input voltage Vi, simultaneously the potential at the external terminal T7 is stepped up to 3Vi (=the input voltage Vi plus the charging voltage 2Vi of the capacitor C2). At this point, since the external terminal T7 is grounded via the switch S7 and the output capacitor Co, the output capacitor Co is charged until the potential difference across it becomes approximately equal to 3Vi.

As described above, in the charge pump circuit of this embodiment, the switches S1 to S8 are switched at regular intervals, producing alternating first and second states described above, so that the capacitor C1 and the capacitor C2 are charged and discharged. As a result, an output voltage Vo (=3Vi) obtained by positively stepping up the input voltage Vi by a factor of 3 is outputted from the output terminal To.

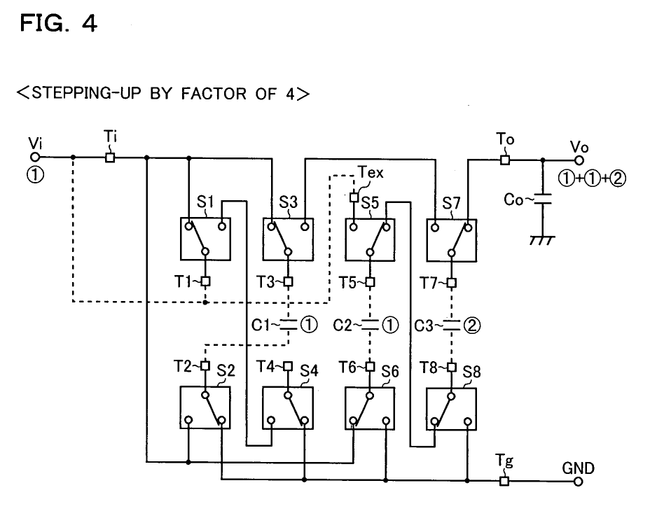

Next, how to form a fourfold charge pump circuit will be specifically described with reference to FIG. 4. FIG. 4 is a diagram showing an example of the connection relationship when stepping-up by a factor of 4 is performed.

As indicated by dashed lines in FIG. 4, to realize stepping-up by a factor of 4, a charge transfer capacitor C1 is externally connected between the external terminal T2 and the external terminal T3, a charge transfer capacitor C2 is externally connected between the external terminal T5 and the external terminal T6, and a charge transfer capacitor C3 is externally connected between the external terminal T7 and the external terminal T8. Furthermore, the input terminal Ti and the external terminal T1 are externally connected to the step-up factor switching terminal Tex.

In the charge pump circuit configured as described above, the external terminal T3 (one end of the capacitor C1) and the external terminal T2 (the other end of the capacitor C1) are first connected respectively to the input terminal Ti via the switch S3 and to the ground terminal Tg via the switch S2 (a first state). As a result of this switching, the input voltage Vi is applied to the external terminal T3, and the ground voltage GND is applied to the external terminal T2. Thus, the capacitor C1 is charged until the potential difference across it becomes approximately equal to the input voltage Vi.

After the capacitor C1 is fully charged, then the external terminal T2 is connected to the input terminal Ti via the switch S2, the external terminal T3 is connected to the external terminal T7 (one end of the capacitor C3) via the switch S3 and the switch S7, and the external terminal T8 (the other end of the capacitor C3) is connected to the ground terminal Tg via the switch S8 (a second state). As a result of this switching, the potential at the external terminal T2 is stepped up from the ground voltage GND to the input voltage Vi. Here, since the capacitor C1 has previously been charged so that now a potential difference approximately equal to the input voltage Vi is present across it, when the potential at the external terminal T2 is stepped up to the input voltage Vi, simultaneously the potential at the external terminal T3 is stepped up to 2Vi (=the input voltage Vi plus the charging voltage Vi of the capacitor C1). At this point, since the external terminal T3 is connected to the ground terminal Tg via the switch S3, the switch S7, the capacitor C3, and the switch S8, the capacitor C3 is charged until the potential difference across it becomes approximately equal to 2Vi.

Furthermore, in the second state described above, the external terminal T5 (one end of the capacitor C2) is connected to the input terminal Ti via the switch S5, and the external terminal T6 (the other end of the capacitor C2) is connected to the ground terminal Tg via the switch S6. As a result of this switching, the input voltage Vi is applied to the external terminal T5, and the ground voltage GND is applied to the external terminal T6. Thus, the capacitor C2 is charged until the potential difference across it becomes approximately equal to the input voltage Vi.

After the capacitor C2 and the capacitor C3 are fully charged, when the switches S1 to S8 are returned to the first state, the external terminal T6 is connected to the input terminal Ti via the switch S6, the external terminal T5 is connected to the external terminal T8 via the switch S5 and the switch S8, and the external terminal T7 is connected to the output terminal To via the switch S7. As a result of this switching, the potential at the external terminal T6 is stepped up from the ground voltage GND to the input voltage Vi. Here, since the capacitor C2 has previously been charged so that now a potential difference approximately equal to the input voltage Vi is present across it and the capacitor C3 has previously been charged so that now a potential difference approximately twice as high as the input voltage Vi is present across it, when the potential at the external terminal T6 is stepped up to the input voltage Vi, simultaneously the potential at the external terminal T7 is stepped up to 4Vi (=the input voltage Vi plus the charging voltage Vi of the capacitor C2 plus the charging voltage 2Vi of the capacitor C3). At this point, since the external terminal T7 is grounded via the switch S7 and the output capacitor Co, the output capacitor Co is charged until the potential difference across it becomes approximately equal to 4Vi.

As described above, in the charge pump circuit of this embodiment, the switches S1 to S8 are switched at regular intervals, producing alternating first and second states described above, so that the capacitors C1 to C3 are charged and discharged. As a result, an output voltage Vo (=4Vi) obtained by positively stepping up the input voltage Vi by a factor of 4 is outputted from the output terminal To.

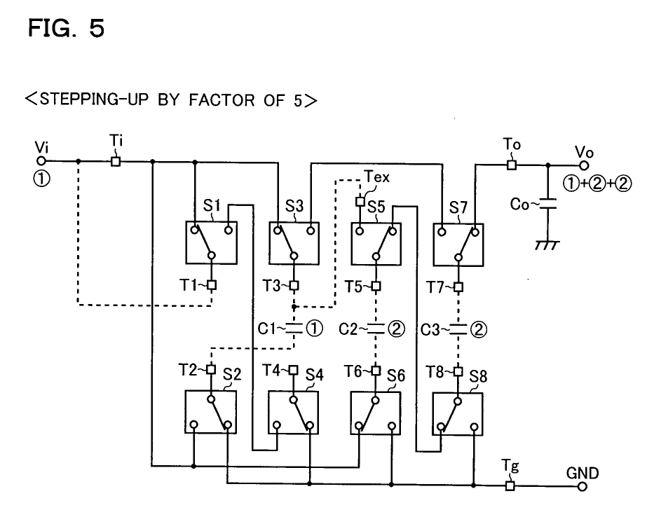

Next, how to form a fivefold charge pump circuit will be specifically described with reference to FIG. 5. FIG. 5 is a diagram showing an example of the connection relationship when stepping-up by a factor of 5 is performed.

As indicated by dashed lines in FIG. 5, to realize stepping-up by a factor of 5, a charge transfer capacitor C1 is externally connected between the external terminal T2 and the external terminal T3, a charge transfer capacitor C2 is externally connected between the external terminal T5 and the external terminal T6, and a charge transfer capacitor C3 is externally connected between the external terminal T7 and the external terminal T8. Furthermore, the external terminal T3 is externally connected to the step-up factor switching terminal Tex.

In the charge pump circuit configured as described above, the external terminal T3 (one end of the capacitor C1) and the external terminal T2 (the other end of the capacitor C1) are first connected respectively to the input terminal Ti via the switch S3 and to the ground terminal Tg via the switch S2 (a first state). As a result of this switching, the input voltage Vi is applied to the external terminal T3, and the ground voltage GND is applied to the external terminal T2. Thus, the capacitor C1 is charged until the potential difference across it becomes approximately equal to the input voltage Vi.

After the capacitor C1 is fully charged, then the external terminal T2 is connected to the input terminal Ti via the switch S2, the external terminal T3 is connected to the external terminal T7 (one end of the capacitor C3) via the switch S3 and the switch S7, and the external terminal T8 (the other end of the capacitor C3) is connected to the ground terminal Tg via the switch S8 (a second state). As a result of this switching, the potential at the external terminal T2 is stepped up from the ground voltage GND to the input voltage Vi. Here, since the capacitor C1 has previously been charged so that now a potential difference approximately equal to the input voltage Vi is present across it, when the potential at the external terminal T2 is stepped up to the input voltage Vi, simultaneously the potential at the external terminal T3 is stepped up to 2Vi (=the input voltage Vi plus the charging voltage Vi of the capacitor C1). At this point, since the external terminal T3 is connected to the ground terminal Tg via the switch S3, the switch S7, the capacitor C3, and the switch S8, the capacitor C3 is charged until the potential difference across it becomes approximately equal to 2Vi.

Furthermore, in the second state described above, the external terminal T5 (one end of the capacitor C2) is connected to the external terminal T3 via the switch S5, and the external terminal T6 (the other end of the capacitor C2) is connected to the ground terminal Tg via the switch S6. That is, the external terminal T3 is connected to the ground terminal Tg not only via a path along which the capacitor C3 is present but also via a path along which the capacitor C2 is present. Thus, like the capacitor C3, the capacitor C2 is charged until the potential difference across it becomes approximately equal to 2Vi.

After the capacitor C2 and the capacitor C3 are fully charged, when the switches S1 to S8 are returned to the first state, the external terminal T6 is connected to the input terminal Ti via the switch S6, the external terminal T5 is connected to the external terminal T8 via the switch S5 and the switch S8, and the external terminal T7 is connected to the output terminal To via the switch S7. As a result of this switching, the potential at the external terminal T6 is stepped up from the ground voltage GND to the input voltage Vi. Here, since the capacitor C2 and the capacitor C3 each have previously been charged so that now a potential difference approximately twice as high as the input voltage Vi is present across them, when the potential at the external terminal T6 is stepped up to the input voltage Vi, simultaneously the potential at the external terminal T7 is stepped up to 5Vi (=the input voltage Vi plus the charging voltage 2Vi of the capacitor C2 plus the charging voltage 2Vi of the capacitor C3). At this point, since the external terminal T7 is grounded via the switch S7 and the output capacitor Co, the output capacitor Co is charged until the potential difference across it becomes approximately equal to 5Vi.

As described above, in the charge pump circuit of this embodiment, the switches S1 to S8 are switched at regular intervals, producing alternating first and second states described above, so that the capacitors C1 to C3 are charged and discharged. As a result, an output voltage Vo (=5Vi) obtained by positively stepping up the input voltage Vi by a factor of 5 is outputted from the output terminal To.

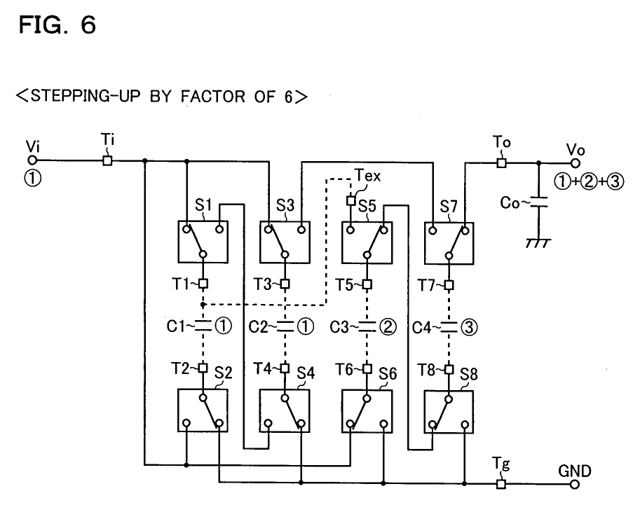

Next, how to form a sixfold charge pump circuit will be specifically described with reference to FIG. 6. FIG. 6 is a diagram showing an example of the connection relationship when stepping-up by a factor of 6 is performed.

As indicated by dashed lines in FIG. 6, to realize stepping-up by a factor of 6, a charge transfer capacitor C1 is externally connected between the external terminal T1 and the external terminal T2, a charge transfer capacitor C2 is externally connected between the external terminal T3 and the external terminal T4, a charge transfer capacitor C3 is externally connected between the external terminal T5 and the external terminal T6, and a charge transfer capacitor C4 is externally connected between the external terminal T7 and the external terminal T8. Furthermore, the external terminal T1 is externally connected to the step-up factor switching terminal Tex.

In the charge pump circuit configured as described above, the external terminal T1 (one end of the capacitor C1), the external terminal T2 (the other end of the capacitor C1), the external terminal T3 (one end of the capacitor C2), and the external terminal T4 (the other end of the capacitor C2) are first connected respectively to the input terminal Ti via the switch S1, to the ground terminal Tg via the switch S2, to the input terminal Ti via the switch S3, and to the ground terminal Tg via the switch S4 (a first state). As a result of this switching, the input voltage Vi is applied to the external terminal T1 and to the external terminal T3, and the ground voltage GND is applied to the external terminal T2 and to the external terminal T4. Thus, the capacitor C1 and the capacitor C2 are each charged until the potential difference across them becomes approximately equal to the input voltage Vi.

After the capacitor C1 and the capacitor C2 are fully charged, then the external terminal T2 is connected to the input terminal Ti via the switch S2, the external terminal T1 is connected to the external terminal T5 (one end of the capacitor C3) via the switch S5, and the external terminal T6 (the other end of the capacitor C3) is connected to the ground terminal Tg via the switch S6 (a second state). As a result of this switching, the potential at the external terminal T2 is stepped up from the ground voltage GND to the input voltage Vi. Here, since the capacitor C1 has previously been charged so that now a potential difference approximately equal to the input voltage Vi is present across it, when the potential at the external terminal T2 is stepped up to the input voltage Vi, simultaneously the potential at the external terminal T1 is stepped up to 2Vi (=the input voltage Vi plus the charging voltage Vi of the capacitor C1). At this point, since the external terminal T1 is connected to the ground terminal Tg via the switch S5, the capacitor C3, and the switch S6, the capacitor C3 is charged until the potential difference across it becomes approximately equal to 2Vi.

Furthermore, in the second state described above, the external terminal T1 is connected also to the external terminal T4 via the switch S1 and the switch S4. As a result of this switching, the potential at the external terminal T4 is stepped up from the ground voltage GND to the voltage (2Vi) applied to the external terminal T1. Here, since the capacitor C2 has previously been charged so that now a potential difference approximately equal to the input voltage Vi is present across it, when the potential at the external terminal T4 is stepped up to 2Vi, simultaneously the potential at the external terminal T3 is stepped up to 3Vi (=the input voltage Vi plus the charging voltage Vi of the capacitor C1 plus the charging voltage Vi of the capacitor C2). At this point, since the external terminal T3 is connected to the ground terminal Tg via the switch S3, the switch S7, the capacitor C4, and the switch S8, the capacitor C4 is charged until the potential difference across it becomes approximately equal to 3Vi.

After the capacitor C3 and the capacitor C4 are fully charged, when the switches S1 to S8 are returned to the first state, the external terminal T6 is connected to the input terminal Ti via the switch S6, the external terminal T5 is connected to the external terminal T8 via the switch S5 and the switch S8, and the external terminal T7 is connected to the output terminal To via the switch S7. As a result of this switching, the potential at the external terminal T6 is stepped up from the ground voltage GND to the input voltage Vi. Here, since the capacitor C3 has previously been charged so that now a potential difference approximately twice as high as the input voltage Vi is present across it and the capacitor C4 has previously been charged so that now a potential difference approximately three times as high as the input voltage Vi is present across it, when the potential at the external terminal T6 is stepped up to the input voltage Vi, simultaneously the potential at the external terminal T7 is stepped up to 6Vi (=the input voltage Vi plus the charging voltage 2Vi of the capacitor C2 plus the charging voltage 3Vi of the capacitor C3). At this point, since the external terminal T7 is grounded via the switch S7 and the output capacitor Co, the output capacitor Co is charged until the potential difference across it becomes approximately equal to 6Vi.

As described above, in the charge pump circuit of this embodiment, the switches S1 to S8 are switched at regular intervals, producing alternating first and second states described above, so that the capacitors C1 to C4 are charged and discharged. As a result, an output voltage Vo (=6Vi) obtained by positively stepping up the input voltage Vi by a factor of 6 is outputted from the output terminal To.

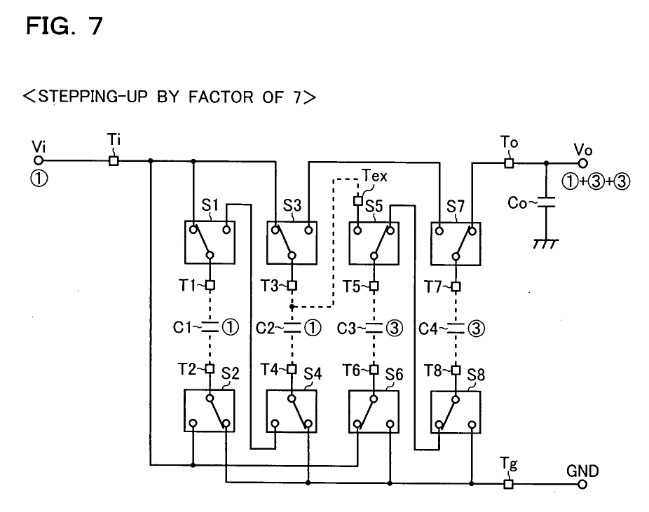

Next, how to form a sevenfold charge pump circuit will be specifically described with reference to FIG. 7. FIG. 7 is a diagram showing an example of the connection relationship when stepping-up by a factor of 7 is performed.

As indicated by dashed lines in FIG. 7, to realize stepping-up by a factor of 7, a charge transfer capacitor C1 is externally connected between the external terminal T1 and the external terminal T2, a charge transfer capacitor C2 is externally connected between the external terminal T3 and the external terminal T4, a charge transfer capacitor C3 is externally connected between the external terminal T5 and the external terminal T6, and a charge transfer capacitor C4 is externally connected between the external terminal T7 and the external terminal T8. Furthermore, the external terminal T3 is externally connected to the step-up factor switching terminal Tex.

In the charge pump circuit configured as described above, the external terminal T1 (one end of the capacitor C1), the external terminal T2 (the other end of the capacitor C1), the external terminal T3 (one end of the capacitor C2), and the external terminal T4 (the other end of the capacitor C2) are first connected respectively to the input terminal Ti via the switch S1, to the ground terminal Tg via the switch S2, to the input terminal Ti via the switch S3, and to the ground terminal Tg via the switch S4 (a first state). As a result of this switching, the input voltage Vi is applied to the external terminal T1 and to the external terminal T3, and the ground voltage GND is applied to the external terminal T2 and to the external terminal T4. Thus, the capacitor C1 and the capacitor C2 are each charged until the potential difference across them becomes approximately equal to the input voltage Vi.

After the capacitor C1 and the capacitor C2 are fully charged, the external terminal T2 and the external terminal T1 are then connected respectively to the input terminal Ti via the switch S2 and to the external terminal T4 via the switch S1 and the switch S4 (a second state). As a result of this switching, the potential at the external terminal T4 is stepped up from the ground voltage GND to the voltage (2Vi) applied to the external terminal T1. Here, since the capacitor C2 has previously been charged so that now a potential difference approximately equal to the input voltage Vi is present across it, when the potential at the external terminal T4 is stepped up to 2Vi, simultaneously the potential at the external terminal T3 is stepped up to 3Vi (=the input voltage Vi plus the charging voltage Vi of the capacitor C1 plus the charging voltage Vi of the capacitor C2). At this point, since the external terminal T3 is connected to the ground terminal Tg via the switch S5, the capacitor C3, and the switch S6, the capacitor C3 is charged until the potential difference across it becomes approximately equal to 3Vi.

Furthermore, in the second state described above, the external terminal T3 is connected to the external terminal T7 (one end of the capacitor C4) via the switch S3 and the switch S7, and the external terminal T8 (the other end of the capacitor C4) is connected to the ground terminal Tg via the switch S8. That is, the external terminal T3 is connected to the ground terminal Tg not only via a path along which the capacitor C3 is present but also via a path along which the capacitor C4 is present. Thus, like the capacitor C3, the capacitor C4 is charged until the potential difference across it becomes approximately equal to 3Vi.

After the capacitor C3 and the capacitor C4 are fully charged, when the switches S1 to S8 are returned to the first state, the external terminal T6 is connected to the input terminal Ti via the switch S6, the external terminal T5 is connected to the external terminal T8 via the switch S5 and the switch S8, and the external terminal T7 is connected to the output terminal To via the switch S7. As a result of this switching, the potential at the external terminal T6 is stepped up from the ground voltage GND to the input voltage Vi. Here, since the capacitor C3 and the capacitor C4 each have previously been charged so that now a potential difference approximately three times as high as the input voltage Vi is present across them, when the potential at the external terminal T6 is stepped up to the input voltage Vi, simultaneously the potential at the external terminal T7 is stepped up to 7Vi (=the input voltage Vi plus the charging voltage 3Vi of the capacitor C2 plus the charging voltage 3Vi of the capacitor C3). At this point, since the external terminal T7 is grounded via the switch S7 and the output capacitor Co, the output capacitor Co is charged until the potential difference across it becomes approximately equal to 7Vi.

As described above, in the charge pump circuit of this embodiment, the switches S1 to S8 are switched at regular intervals, producing alternating first and second states described above, so that the capacitors C1 to C4 are charged and discharged. As a result, an output voltage Vo (=7Vi) obtained by positively stepping up the input voltage Vi is outputted from the output terminal To.

As described above, with the semiconductor integrated circuit device of this embodiment, by appropriately changing the terminal to which the step-up factor switching terminal Tex is externally connected and changing how many and where charge transfer capacitors are connected between the external terminals T1 to T8, it is possible to change the internal circuit configuration thereof to any desired configuration. This makes it possible to set a step-up factor of a charge pump circuit built with this semiconductor integrated circuit device to any desired factor in the two- to sevenfold range.

Accordingly, the user can form the charge pump circuits having different step-up factors only by obtaining the semiconductor integrated circuit device of this embodiment. This eliminates the possibility of the wrong semiconductor integrated circuit device being chosen. Furthermore, the manufacturers of the semiconductor integrated circuit devices can satisfy the varied needs of users only by making available the semiconductor integrated circuit device of this embodiment. This makes it possible to unify the production of semiconductor integrated circuit devices, which have been produced separately for each step-up factor, and improve production efficiency.

Incidentally, to change a step-up factor, a configuration in which a group of switches for changing the internal circuit configuration of a semiconductor integrated circuit device are integrated into the semiconductor integrated circuit device or a configuration in which a plurality of output terminals for outputting different output voltages are provided may be adopted. However, adopting such a configuration involves greatly increasing circuit size or the number of external terminals. Accordingly, from a viewpoint of avoiding such drawbacks, it is preferable to adopt a configuration of this embodiment that only requires a step-up factor switching terminal Tex to be added.

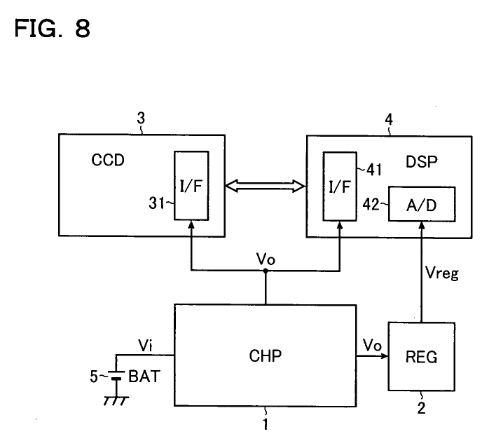

FIG. 8 is a block diagram showing a portable device (e.g., a cellular phone terminal with a camera) incorporating a charge pump circuit according to the invention.

As shown in FIG. 8, the portable device of this embodiment includes a charge pump circuit 1, a regulator circuit 2 that produces a desired regulated voltage Vreg from an output voltage Vo of the charge pump circuit 1, an imaging device 3 built with a CCD (charge coupled device) and the like, a DSP (digital signal processor) 4 that performs computations on digital signals obtained in the imaging device 3, and a DC (direct-current) voltage source 5 such as a lithium battery. Furthermore, this portable device includes, though not illustrated, a communication circuit, a display circuit, and the like, to function as a cellular phone terminal.

The charge pump circuit 1 produces a desired output voltage Vo by stepping up an input voltage Vi supplied from the DC voltage source 5, and feeds it to a load as an operating voltage thereof. In this embodiment, as an example of implementation, the output voltage Vo is fed to an interface circuit 31 of the imaging device 3 and to an interface circuit 41 of the DSP 4. It is to be understood, however, that a load to which the output voltage Vo is fed is not limited to this specific example.

The regulator circuit 2 feeds the regulated voltage Vreg to a load that needs a voltage different from the output voltage Vo, such as an A/D converter 42 of the DSP 4.

Although the embodiment described above deals with a semiconductor integrated circuit device that can be used to form two- to sevenfold step-up charge pump circuits, this is not meant to limit the application of the invention in any way: the invention may be practiced in any other manner than specifically described above, with any modification or variation made within the spirit of the invention.

Defined in broader terms, a semiconductor integrated circuit device according to the invention includes at least the following features. The semiconductor integrated circuit device includes an input terminal to which an input voltage is applied, an output terminal from which an output voltage is outputted, a ground terminal to which a ground voltage is applied, a plurality of external terminals to which a charge transfer capacitor is externally fitted, and a plurality of charge transfer switches provided one for each of the external terminals, wherein the plurality of charge transfer switches each have a common contact connected to a corresponding one of the external terminals and two selection contacts alternatively connected to the common contact, and one of the selection contacts of the plurality of charge transfer switches is connected to a step-up factor switching terminal that can be externally connected to at least one of the input terminal and the plurality of external terminals, and each of the other selection contacts is connected to one of the input terminal, the output terminal, the ground terminal, and the rest of the other selection contacts.

As described above, the essence of the present invention lies in that a semiconductor integrated circuit device includes a step-up factor switching terminal for changing a step-up factor, so that the internal circuit configuration of the device can be changed to any desired configuration by appropriately changing the terminal to which the step-up factor switching terminal is externally connected. Therefore, for example, the number of external terminals to which a charge transfer capacitor is externally fitted or the number of charge transfer switches, and even the internal connection relationship therebetween may be different from what has been specifically described above, because such modifications are made to change, where appropriate, the range where the step-up factor can be changed or the step-up polarity (positive/negative stepping-up) and thus considered to be insignificant. Thus, a semiconductor integrated circuit device involving such modifications also embodies the technical idea of the present invention.

According to the present invention, it is possible to provide versatile semiconductor integrated circuit devices that can be used to form charge pump circuits having different step-up factors, and to provide charge pump circuits and electric appliances provided with such semiconductor integrated circuit devices.

The present invention is useful in improving the versatility of semiconductor integrated circuit devices for use in charge pump power supply devices.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the present invention which fall within the true spirit and scope of the invention.

What is claimed is:

1. A semiconductor integrated circuit device, comprising:
an input terminal to which an input voltage is applied;
an output terminal from which an output voltage is outputted;
a ground terminal to which a ground voltage is applied;
first to eighth external terminals to which a charge transfer capacitor is externally fitted;
first to eighth charge transfer switches provided one for each of the first to eighth external terminals; and
a step-up factor switching terminal provided separately from said terminals for changing a step-up factor,
wherein the first to eighth charge transfer switches each have a common contact connected to corresponding one of the external terminals and first and second selection contacts alternatively connected to the common contact,
wherein the first charge transfer switch is connected, at the first selection contact thereof, to the input terminal and is connected, at the second selection contact thereof, to the first selection contact of the fourth charge transfer switch,
wherein the second charge transfer switch is connected, at the first selection contact thereof, to the input terminal and is connected, at the second selection contact thereof, to the ground terminal,
wherein the third charge transfer switch is connected, at the first selection contact thereof, to the input terminal and is connected, at the second selection contact thereof, to the first selection contact of the seventh charge transfer switch,
wherein the fourth charge transfer switch is connected, at the second selection contact thereof, to the ground terminal,
wherein the fifth charge transfer switch is connected, at the first selection contact thereof, to the step-up factor switching terminal and is connected, at the second selection contact thereof, to the first selection contact of the eighth charge transfer switch,
wherein the sixth charge transfer switch is connected, at the first selection contact thereof, to the input terminal and is connected, at the second selection contact thereof, to the ground terminal,
wherein the seventh charge transfer switch is connected, at the second selection contact thereof, to the output terminal,
wherein the eighth charge transfer switch is connected, at the second selection contact thereof, to the ground terminal,
wherein path switching control is performed for the first, third, sixth, and eighth charge transfer switches and for the second, fourth, fifth, and seventh charge transfer switches in such a way that a former become opposite in phase to a latter.

2. A charge pump circuit, comprising:
a semiconductor integrated circuit device;
at least one charge transfer capacitor; and
at least one output capacitor,
wherein the semiconductor integrated circuit device comprises:
an input terminal to which an input voltage is applied;
an output terminal from which an output voltage is outputted;
a ground terminal to which a ground voltage is applied;
first to eighth external terminals to which the at least one charge transfer capacitor is externally fitted;
first to eighth charge transfer switches provided one for each of the first to eighth external terminals; and
a step-up factor switching terminal provided separately from said terminals for changing a step-up factor,
wherein the first to eighth charge transfer switches each have a common contact connected to corresponding one of the external terminals and first and second selection contacts alternatively connected to the common contact,
wherein the first charge transfer switch is connected, at the first selection contact thereof, to the input terminal and is connected, at the second selection contact thereof, to the first selection contact of the fourth charge transfer switch,
wherein the second charge transfer switch is connected, at the first selection contact thereof, to the input terminal and is connected, at the second selection contact thereof, to the ground terminal,
wherein the third charge transfer switch is connected, at the first selection contact thereof, to the input terminal and is connected, at the second selection contact thereof, to the first selection contact of the seventh charge transfer switch,
wherein the fourth charge transfer switch is connected, at the second selection contact thereof, to the ground terminal,
wherein the fifth charge transfer switch is connected, at the first selection contact thereof, to the step-up factor switching terminal and is connected, at the second selection contact thereof, to the first selection contact of the eighth charge transfer switch,
wherein the sixth charge transfer switch is connected, at the first selection contact thereof, to the input terminal and is connected, at the second selection contact thereof, to the ground terminal,
wherein the seventh charge transfer switch is connected, at the second selection contact thereof, to the output terminal,
wherein the eighth charge transfer switch is connected, at the second selection contact thereof, to the ground terminal,
wherein path switching control is performed for the first, third, sixth, and eighth charge transfer switches and for the second, fourth, fifth, and seventh charge transfer switches in such a way that a former become opposite in phase to a latter,
wherein a desired output voltage is produced from the input voltage by charging and discharging the at least one charge transfer capacitor by switching the first to eighth charge transfer switches at regular intervals.

3. The charge pump circuit of claim 2, wherein
a first charge transfer capacitor is externally connected between the seventh and eighth external terminals, and the input terminal, the first external terminal, the third external terminal, and the fifth external terminal are externally connected to the step-up factor switching terminal, so that the input voltage is stepped up by a factor of 2 to produce the output voltage.

4. The charge pump circuit of claim 2, wherein
a first charge transfer capacitor is externally connected between the fifth and sixth external terminals, a second charge transfer capacitor is externally connected between the seventh and eighth external terminals, and the input terminal, the first external terminal, and the third external terminal are externally connected to the step-up factor switching terminal, so that the input voltage is stepped up by a factor of 3 to produce the output voltage.

5. The charge pump circuit of claim 2, wherein
a first charge transfer capacitor is externally connected between the second and third external terminals, a second charge transfer capacitor is externally connected between the seventh and eighth external terminals, and the input terminal, the first external terminal, and the fifth external terminal are externally connected to the step-up factor switching terminal, so that the input voltage is stepped up by a factor of 3 to produce the output voltage.

6. The charge pump circuit of claim 2, wherein
a first charge transfer capacitor is externally connected between the second and third external terminals, a second charge transfer capacitor is externally connected between the fifth and sixth external terminals, a third charge transfer capacitor is externally connected between the seventh and eighth external terminals, and the input terminal and the first external terminal are externally connected to the step-up factor switching terminal, so that the input voltage is stepped up by a factor of 4 to produce the output voltage.

7. The charge pump circuit of claim 2, wherein
a first charge transfer capacitor is externally connected between the second and third external terminals, a second charge transfer capacitor is externally connected between the fifth and sixth external terminals, a third charge transfer capacitor is externally connected between the seventh and eighth external terminals, and the third external terminal is externally connected to the step-up factor switching terminal, so that the input voltage is stepped up by a factor of 5 to produce the output voltage.

8. The charge pump circuit of claim 2, wherein
a first charge transfer capacitor is externally connected between the first and second external terminals, a second charge transfer capacitor is externally connected between the third and fourth external terminals, a third charge transfer capacitor is externally connected between the fifth and sixth external terminals, a fourth charge transfer capacitor is externally connected between the seventh and eighth external terminals, and the first external terminal is externally connected to the step-up factor switching terminal, so that the input voltage is stepped up by a factor of 6 to produce the output voltage.

9. The charge pump circuit of claim 2, wherein
a first charge transfer capacitor is externally connected between the first and second external terminals, a second charge transfer capacitor is externally connected between the third and fourth external terminals, a third charge transfer capacitor is externally connected between the fifth and sixth external terminals, a fourth charge transfer capacitor is externally connected between the seventh and eighth external terminals, and the third external terminal is externally connected to the step-up factor switching terminal, so that the input voltage is stepped up by a factor of 7 to produce the output voltage.

10. An electric appliance, comprising:
a DC voltage source that produces an input voltage;
a charge pump circuit that produces a desired output voltage from the input voltage; and
a load that is fed with the output voltage as an operating voltage thereof,
wherein the charge pump circuit comprises:
a semiconductor integrated circuit device;
at least one charge transfer capacitor; and
at least one output capacitor,
wherein the semiconductor integrated circuit device comprises:
an input terminal to which the input voltage is applied;
an output terminal from which the output voltage is outputted;
a ground terminal to which a ground voltage is applied;
first to eighth external terminals to which the at least one charge transfer capacitor is externally fitted;
first to eighth charge transfer switches provided one for each of the first to eighth external terminals; and
a step-up factor switching terminal provided separately from said terminals for changing a step-up factor,
wherein the first to eighth charge transfer switches each have a common contact connected to corresponding one of the external terminals and first and second selection contacts alternatively connected to the common contact,
wherein the first charge transfer switch is connected, at the first selection contact thereof, to the input terminal and is connected, at the second selection contact thereof, to the first selection contact of the fourth charge transfer switch,
wherein the second charge transfer switch is connected, at the first selection contact thereof, to the input terminal and is connected, at the second selection contact thereof, to the ground terminal,
wherein the third charge transfer switch is connected, at the first selection contact thereof, to the input terminal and is connected, at the second selection contact thereof, to the first selection contact of the seventh charge transfer switch,
wherein the fourth charge transfer switch is connected, at the second selection contact thereof, to the ground terminal,
wherein the fifth charge transfer switch is connected, at the first selection contact thereof, to the step-up factor switching terminal and is connected, at the second selection contact thereof, to the first selection contact of the eighth charge transfer switch,
wherein the sixth charge transfer switch is connected, at the first selection contact thereof, to the input terminal and is connected, at the second selection contact thereof, to the ground terminal,
wherein the seventh charge transfer switch is connected, at the second selection contact thereof, to the output terminal,
wherein the eighth charge transfer switch is connected, at the second selection contact thereof, to the ground terminal,
wherein path switching control is performed for the first, third, sixth, and eighth charge transfer switches and for the second, fourth, fifth, and seventh charge transfer switches in such a way that a former become opposite in phase to a latter,
wherein the desired output voltage is produced from the input voltage by charging and discharging the at least one charge transfer capacitor by switching the first to eighth charge transfer switches at regular intervals.

11. A semiconductor integrated circuit device, comprising:
an input terminal to which an input voltage is applied;
an output terminal from which an output voltage is outputted;
a ground terminal to which a ground voltage is applied;
a plurality of external terminals to which a charge transfer capacitor is externally fitted; and
a plurality of charge transfer switches provided one for each of the external terminals,
wherein the plurality of charge transfer switches each have a common contact connected to corresponding one of the external terminals and two selection contacts alternatively connected to the common contact,
wherein one of the selection contacts of the plurality of charge transfer switches is connected to a step-up factor switching terminal that can be externally connected to at least one of the input terminal and the plurality of external terminals,
wherein each of the other selection contacts is connected to one of the input terminal, the output terminal, the ground terminal, and a rest of the other selection contacts.

12. A charge pump circuit, comprising:
a semiconductor integrated circuit device;
at least one charge transfer capacitor; and
at least one output capacitor,
wherein the semiconductor integrated circuit device comprises:
an input terminal to which an input voltage is applied;
an output terminal from which an output voltage is outputted;
a ground terminal to which a ground voltage is applied;
a plurality of external terminals to which the at least one charge transfer capacitor is externally fitted; and
a plurality of charge transfer switches provided one for each of the external terminals,
wherein the plurality of charge transfer switches each have a common contact connected to corresponding one of the external terminals and two selection contacts alternatively connected to the common contact,
wherein one of the selection contacts of the plurality of charge transfer switches is connected to a step-up factor switching terminal that can be externally connected to at least one of the input terminal and the plurality of external terminals,
wherein each of the other selection contacts is connected to one of the input terminal, the output terminal, the ground terminal, and a rest of the other selection contacts,
wherein a desired output voltage is produced from the input voltage by charging and discharging the at least one charge transfer capacitor by switching the plurality of charge transfer switches at regular intervals.

13. An electric appliance, comprising:
a DC voltage source that produces an input voltage;
a charge pump circuit that produces a desired output voltage from the input voltage; and
a load that is fed with the output voltage as an operating voltage thereof,
wherein the charge pump circuit comprises:
a semiconductor integrated circuit device;
at least one charge transfer capacitor; and
at least one output capacitor,
wherein the semiconductor integrated circuit device comprises:
an input terminal to which the input voltage is applied;
an output terminal from which the output voltage is outputted;
a ground terminal to which a ground voltage is applied;
a plurality of external terminals to which the at least one charge transfer capacitor is externally fitted; and
a plurality of charge transfer switches provided one for each of the external terminals,
wherein the plurality of charge transfer switches each have a common contact connected to corresponding one of the external terminals and two selection contacts alternatively connected to the common contact,
wherein one of the selection contacts of the plurality of charge transfer switches is connected to a step-up factor switching terminal that can be externally connected to at least one of the input terminal and the plurality of external terminals,
wherein each of the other selection contacts is connected to one of the input terminal, the output terminal, the ground terminal, and a rest of the other selection contacts,
wherein the desired output voltage is produced from the input voltage by charging and discharging the at least one charge transfer capacitor by switching the plurality of charge transfer switches at regular intervals.
